(19) United States
(12) Patent Application Publication
(10) Pub. No.: US 2026/0341299 A1
(43) Pub. Date: Oct. 29, 2026

(54) SAFETY CLASSIFIERS FOR AUDIO OUTPUT

(71) Applicant: OpenAI OpCo, LLC., San Francisco, CA (US)

(72) Inventors: Madelaine Boyd, San Francisco, CA (US); Saachi Jain, San Francisco, CA (US); Michael Lampe, San Francisco, CA (US); Zhansheng Phang, San Francisco, CA (US); Filippo Raso, Davis, CA (US); Jackie Shannon, San Francisco, CA (US); Samuel Toizer, Oakland, CA (US); Andrea Vallone, San Francisco, CA (US)

(73) Assignee: OpenAI OpCo, LLC, San Francisco, CA (US)

(21) Appl. No.: 19/188,100

(22) Filed: Apr. 24, 2025

(51) Int. Cl. G10L 25/51; G10L 15/06; G10L 15/22

(52) U.S. Cl. CPC G10L 25/51; G10L 15/063; G10L 15/22

(57) ABSTRACT

In one aspect, a method includes determining, by the safety engine, for a first window of the audio stream, a first score indicating a similarity between audio of the first window of the audio stream and a reference voice, where the first score is output from a classifier; and determining, for a second window of the audio stream, a second score indicating a similarity between audio of the second window of the audio stream and the reference voice, where the second score is output from the classifier, where the first score and the second score are usable in determining whether to output the first window of the audio stream and the second window of the audio stream.

### BACKGROUND

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation. Generative response engines can sift through vast amounts of text data, extract context, and provide coherent responses to a wide array of queries.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1 illustrates an example system supporting a generative response engine during inference operations in accordance with some aspects of the present technology.

FIG. 2 illustrates an aspect of the subject matter in accordance with some aspects of the present technology.

FIG. 3 illustrates an example method for determining whether to provide audio output of a generative response engine based on whether the audio output contains a voice deviating from a reference voice in accordance with some aspects of the present technology.

FIG. 4 illustrates an example method 400 for determining whether to provide audio output of a generative response engine based on whether the audio output contains music in accordance with some aspects of the present technology.

FIG. 5 is a block diagram illustrating an example machine-learning platform for implementing various aspects of this disclosure in accordance with some aspects of the present technology.

FIGS. 6A, 6B, and 6C illustrate an example transformer architecture in accordance with some aspects of the present technology.

FIG. 7 shows an example of a system for implementing some aspects of the present technology.

### DETAILED DESCRIPTION

Various aspects of the disclosure are discussed in detail below. While specific implementations are discussed, it should be understood that this is done for illustration purposes only. A person skilled in the relevant art will recognize that other components and configurations may be used without parting from the spirit and scope of the disclosure.

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation.

Many generative response engines provide a conversational user interface powered by a chatbot whereby the user account interacts with the generative response engine through natural language conversation with the chatbot. Such a user interface provides an intuitive format to provide prompts or instructions to the generative response engine. In fact, the conversational user interface powered by the chatbot can be so effective that users can feel as if they are interacting with a person. Some user accounts find the generative response engine effective enough that they utilize the conversational user interface powered by the chatbot as they would an assistant.

While generative response engines represent a powerful tool for generating multi-modal outputs, such as audio, text, visual media, there is potential for misuse - either accidental or malicious. With respect to audio output by a generative response engine, there is a risk, depending on the particular prompts used by a user account, of outputting copyrighted material (e.g., music) or of outputting audio using a voice that resembles that of a particular person. Particularly with respect to audio output containing a voice, there is potential for malicious use in generating audio files with a voice mimicking that of a famous person (e.g., a celebrity or politician). In some cases, generative response engines may be configured to or trained to only output content using particular reference voices or to not output music. Accordingly, there is a need for systems and methods to prevent generative response engines from providing certain types of audio output to a user and/or to confirm that generative response engines are not providing certain types of audio output to a user.

The present technology aims to address these and other challenges associated with outputting, by a generative response engine, audio output. For example, the present technology can include a moderation system configured to moderate audio output from a generative response engine. The moderation system can ensure responsible use of generative response engines that complies with legal and ethical guidelines. For example, the content moderation system can detect potentially problematic audio output by a generative response engine and prevent this output from being provided to the user. This can prevent risky audio from being output by the generative response engine, whether prompted by a user account maliciously or accidentally. In some examples, the content moderation system can be a system separate from the generative response engine. In another example, the content moderation system can be part of a system providing a generative response engine.

To achieve these improvements, systems and methods include outputting, by the generative response engine audio content to a safety engine, prior to providing the audio content to the front end to be output to the user. The safety engine can include a classifier configured to output a score based on audio content of one or more windows of audio output. The score can indicate, for example, an amount of deviation of a voice in the audio output from a licensed voice sample. In another example, the score can indicate a likelihood that the audio output contains music. By comparing these scores to predetermined threshold scores, the safety engine can determine whether or not to provide the audio output to the front end.

As an example, for preventing voice spoofing or audio deep fakes, the safety engine can analyze overlapping windows of audio output. For example, for a first window of audio output, the safety engine can receive a score from a classifier where the score is indicative of an amount that a voice in the audio output deviates from a voice sample. This score can be compared with a predetermined threshold score, such that if the score is greater than the threshold score, then the voice in the audio output is determined to deviate from the allowed output voice based on the voice sample by greater than an allowed amount of deviation. This process can be repeated for a second window of audio output, such that if the score in two successive windows of audio output indicate deviation from the allowed voice sample, the safety engine prevents the audio output from being provided to the front end, thereby preventing the audio output from being provided to a user.

In another example, to prevent output of music, which may possibly be subject to copyright or licensing restrictions, the safety engine can, for a first audio window, receive a score from a classifier, where the score indicates whether or not the first window of audio contains music. If the score is greater than a predetermined threshold score, the first audio clip can be considered to contain music. This process can be repeated for a second window of audio output, such that if the score in two successive windows of audio output indicate that both audio outputs contain music, the safety engine prevents the audio output from being provided to the front end, thereby preventing the audio output from being provided to a user.

Accordingly, aspects of the present technology can prevent risky audio output (e.g., music or a voice sample mimicking that of a real person) from being output to a user, while balancing performance by not introducing undue lag, which could reduce the user experience. This can prevent, for example, intentional or accidental misuse of the generative response engine to output copyrighted material or to generate audio output in a particular person's voice without permission. Further, disclosed systems and methods enable safety checks on audio output without hindering the user experience by introducing a significant lag in outputting the response to the user. Accordingly, the present technology enables model output to conform with legal and ethical guidelines without impacting the user experience.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

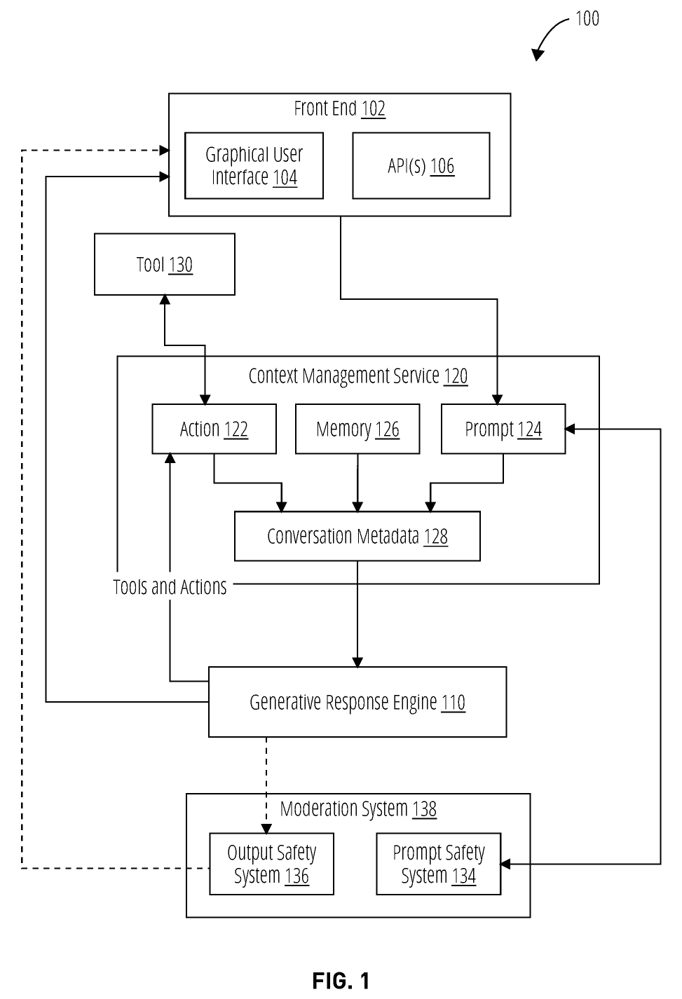

FIG. 1 illustrates an example AI assistant service supporting a generative response engine during inference operations in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

The generative response engine 110 is an artificial intelligence (AI) that can generate content in response to a prompt. The prompt can be from a human or a software entity (AI or applications). The prompt is generally in natural language but could be in code, including binary. Some examples of the generative response engine can include language models that generate language, such as CHATGPT, or other models, such as DALL-E, which generates images, and SORA, which generates videos. CHATGPT, DALL-E, and SORA are all provided by OPENAI, but the generative response engine is not limited to AI provided by OPENAI. The generative response engine can also be any type of generative AI and can include AI developed using various architectures such as diffusion models and transformers (e.g., autoregressive transformer architecture) and combinations of models.

In some instances, a language model, such as CHATGPT, can receive prompts to output images, video, code, applications, etc., which it can provide by interfacing with one or more other models, as will be addressed further herein.

Users and applications can interact with the generative response engine 110 through the front end 102. The front end 102 serves as the interface and intermediary between the user and the generative response engine. It encompasses the graphical user interface 104 and Application Programming Interfaces (APIs) 106 that facilitate communication, input processing, and output presentation. Generally, users interact through a graphical user interface 104 that often includes a conversational interface, and applications interact through the API 106, but this is not a requirement.

The graphical user interface 104 is the platform through which users interact with the generative response engine 110. It can be a web-based chat window, a mobile application, or any interface that supports data input and output. The graphical user interface 104 facilitates a conversation between the user and the generative response engine, as the user provides prompts in the graphical user interface 104 to which the generative response engine responds and presents those responses in the graphical user interface 104. In some aspects, graphical user interface 104 presents a conversational interface, which has attributes of a conversation thread between a user account and generative response engine 110.

The graphical user interface 104 is configured to perform input handling, context management, and output presentation. The type of inputs that can be received can be relative to the specifics of the generative response engine 110. For example, a language model is generally configured to accept text, but when the generative response engine is a multi-modal generative response engine, the front end 102 can accept voice and images/video.

In some aspects, front end 102 can be an interface to accept any input types as part of the prompt, and downstream services can determine which generative response engine or collection of generative response engines are best suited to respond to the prompt.

The graphical user interface 104 is also configured to maintain the context of the conversation, which allows for coherent and relevant responses. For example, the graphical user interface 104 is responsible for providing the conversation thread and other relevant context accessible to the front end 102 to the generative response engine along with the specific prompt to the generative response engine. In an example, a conversation between the user account and the generative response engine 110 can have taken several turns (prompt, response, prompt, response, etc.). When the user account provides a further prompt, the graphical user interface 104 can provide that prompt to the generative response engine in the context of the entire conversation.

In another example, the graphical user interface 104 might be configured to provide a system prompt along with a user-provided prompt. A system prompt is hidden from the user account and is used to set the behavior and guidelines for the generative response engine. It can be used to define the AI’s persona, style, and constraints. There can be levels of system prompts. A highest level of a system prompt might be provided by the generative response engine 110 provider and is meant to establish policies for the behavior of generative response engine 110. This highest level of system prompt should be prohibited from being edited. A customization system prompt can be used to customize the behavior of the generative response engine and is often provided through an API call, or provided by a user account when creating a customized version of generative response engine 110. A still lower level of system prompt might include hidden information about a task. This can include chain-of-thought from a reasoning model, or context about an application the generative response engine 110 is working with to complete a task. Accordingly, the graphical user interface 104 does not always display all of the output of the generative response engine.

The graphical user interface 104 is also configured to display the responses from the generative response engine, which might include text, code snippets, images, or interactive elements.

In some aspects, the generative response engine 110 can provide instructions to the front end 102 that instruct the graphical user interface 104 about how to display some of the output from the generative response engine. For example, the generative response engine can direct the graphical user interface 104 to present code in a code-specific format, or to present interactive graphics, or static images. In other examples, the generative response engine can direct the graphical user interface 104 to present an interactive document editor where the graphical user interface 104 can be presented with the document editor so that the user account and the generative response engine can collaborate on the document.

In some aspects, the generative response engine 110 can provide instructions memory 126 to record facts in a personalization notepad, and front end 102 can be configured to notify the user account that a memory was created.

As noted above, the front end 102 can also provide one or more application programming interfaces (API(s)) 106. APIs enable developers to integrate the generative response engine’s capabilities into external applications and services. They provide programmatic access to the generative response engine, allowing for customized interactions and functionalities. While APIs 106 are shown as part of a front end 102, this illustration takes the liberty of locating API 106 in front end 102 to refer to points of access to generative response engine 110 (i.e., graphical user interface 104 and APIs 106 are points of access and generative response engine 110 sends and receives messages to them in similar ways). In reality, API 106 endpoints are located at context management service 120.

The APIs 106 can accept structured requests containing prompts, context, and configuration parameters. For example, an API can be used to provide prompts and divide the prompt into system prompts and user prompts. In some aspects, the APIs 106 can provide specific inputs for which the generative response engine 110 is configured to respond with a specific behavior. For example, an API can be used to specify that it requires an output in a particular format or structured output. For example, in the chat completion API, the API call can specify parameters for the output, such as the max length for the desired output, and specify aspects of the tone of the language used in the response. Some common APIs are for participating in a conversation (Chat Completion API), for providing a single response (Completion API), for converting text into embeddings (Embeddings API), etc. The API can also be used to indicate specific decision boundaries that the generative response engine 110 might be trained to interpret. For example, the moderation API can take advantage of the AI assistant service 100's content moderation decision-making. In the case of the moderation API and others, the API might give access to services other than the generative response engine. For example, the moderation API might be an interface to moderation system 138, addressed below.

Some other common APIs include the Fine-Tuning API, which allows developers to customize models of the generative response engine using their own datasets; the Audio and Speech APIs, which cause the generative response engine to output speech or audio; and the Image Generation API, which causes the generative response engine to output images (which might require utilizing other models).

There can also be APIs that direct the generative response engine to interface with other applications or other generative AI engines. In such cases, the specific application or AI engine might be specified, or the generative response engine might be allowed to choose another application of AI engine to utilize in response to a prompt.

In short, the graphical user interface 104 and the APIs 106 can be used to provide prompts to the generative response engine. Prompts are sometimes differentiated into prompt types. For example, a system prompt can be a hidden prompt that sets the behavior and guidelines for the generative response engine. A user prompt is the explicit input provided by the user, which may include questions, commands, or information.

Sitting in between front end 102 and generative response engine 110 is a context management service 120. The function of context management service 120 is to manage and organize the flow of data among key subsystems, enabling the generative response engine 110 to generate responses that are contextually relevant, accurate, and enriched with additional information as required.

Action 122 facilitates auxiliary tasks that extend beyond basic text generation. In some aspects, action 122 can be actions that correspond to an API 106. In some aspects, action 122 can be agentic actions that the generative response engine 110 decides to take to carry out a user's intent as described in the prompt. For example, an action can be to call tool 130 or even another generative response engine 110.

Prompt 124 is the request or command provided by the user account through front end 102. In some aspects, prompt 124 can be further supplemented by a system prompt and other information that might be included by graphical user interface 104 or API 106 or associated with a custom generative response engine 110. In some aspects, prompt 124 can even be modified or enhanced by generative response engine 110 as addressed further below. Additionally, as the user account provides prompts and generative response engine 110 provides responses, a conversation thread forms. As the user account provides a new prompt, this is appended to the overall conversation and added to prompt 124. Thus, a user account might think of a first user-provided message as a first prompt and a second user-provided message as a second prompt, and so on, but prompt 124 as perceived by generative response engine 110 can include a thread of user-provided messages and responses from generative response engine 110 in a multi-turn conversation. The actors in the conversation thread can be labeled so that generative response engine 110 can review the turns of the conversation. Generally, prompt 124 will include an entire conversation thread, but in some instances, prompt 124 might need to be shortened if it exceeds a maximum accepted length (generally measured by a number of tokens).

Context management service 120 can also route prompts and response through moderation system 138. In some aspects, prompts are provided to prompt safety system 134 before being provided to generative response engine 110. Prompt safety system 134 is configured to use one or more techniques to evaluate prompts to ensure a prompt is not requesting generative response engine 110 to generate moderated content. In some aspects, prompt safety system 134 can utilize text pattern matching, classifiers, and/or other AI techniques.

Since prompts can evolve over time through the course of a conversation, consisting of prompts and responses, prompts can be repeatedly evaluated at each turn in the conversation.

Memory 126 can facilitate continuity and personalization in conversations. It allows the system to maintain user-specific context, preferences, or details that may inform future interactions. A memory file can be persisted data from previous interactions or sessions that provide background information to maintain continuity. In some aspects, memory can be recorded at the instruction of generative response engine 110 when generative response engine 110 identifies a fact or data that it determines should be saved in memory because it might be useful in later conversations or sessions. In some aspects, memory 126 can also include synthesized concepts extracted from past conversation threads, and memory 126 can also encompass the ability of generative response engine 110 to search through past interactions to find relevant information to a current conversation thread.

Conversation metadata 128 can aggregate data points relevant to the conversation, including user prompt 124, action 122, and memory 126. This consolidated information package serves as the input for generative response engine 110. Conversation metadata 128 can label parts of a prompt as user provided, generative response engine provided, a system prompt, memory 126, data from action 122 or tool 130 (addressed below).

The generative response engine is the core engine that processes inputs (from context management service 120) and generates outputs. In some aspects, the generative response engine is a generative transformer, or autoregressive transformer, but it could utilize other architectures. In some examples, the transformer is multi-modal transformer that can use audio tokens (or embeddings thereof), visual tokens (or embeddings thereof), and language (or embeddings thereof) as needed.

A core feature of the generative response engine 110 is to generate content in response to prompts. The generative response engine 110 is configured to receive inputs from front end 102 that provide guidance on a desired output. The generative response engine can analyze the input and identify relevant patterns and associations in the data, and it has learned to generate a sequence of tokens that are predicted as the most likely continuation of the input. The generative response engine 110 generates responses by sampling from the probability distribution of possible tokens, guided by the patterns observed during its training. Two features of the autoregressive transformer that result in this functionality are that the autoregressive transformer might use only the decoder part of the transformer architecture and that it utilizes self-attention. By utilizing the decoder part of the transformer architecture, the transformer focuses on predicting the tokens given the previous context tokens. And the self-attention mechanism captures long-range dependencies amongst tokens, allowing it to generate contextually relevant responses (in text, audio, images, and video).

In some aspects, the generative response engine 110 can generate multiple possible responses before presenting the final one. The generative response engine 110 can generate multiple responses based on the input, and these responses are variations that the generative response engine 110 considers potentially relevant and coherent.

In some aspects, the generative response engine 110 can evaluate generated responses based on certain criteria. These criteria can include relevance to the prompt, coherence, fluency, and sometimes adherence to specific guidelines or rules, depending on the application. Based on this evaluation, the generative response engine 110 can select the most appropriate response. This selection is typically the one that scores highest on the set criteria, balancing factors like relevance, informativeness, coherence, and content moderation instructions/training.

In some aspects, an instruction provided by an API 106, a system prompt, or a decision made by generative response engine 110 can cause the generative response engine 110 to interpret a prompt and re-write it or improve the prompt for a desired purpose. For example, generative response engine 110 can determine to take a prompt to make a picture and enhance the prompt to yield a better picture. In these instances, generative response engine 110 can generate its own prompts, which can be provided to a tool 130 or provided to generative response engine 110 to yield a better output response than the original prompt might have.

The generative response engine 110 can also do more than generate content in response to a prompt. In some aspects, the generative response engine 110 can utilize decision boundaries to determine the appropriate course of action based on the prompt. In some examples, a decision boundary might be used to cause the generative response engine to recognize that it is being asked to provide a response in a particular format such that it will generate its response constrained by the particular format. In some examples, a decision boundary can cause the model to refuse to generate a responsive output if the decision is that the responsive output would violate a moderation policy. In some examples, the decision boundary might cause the generative response engine to recognize that it needs to interface with another AI model or application to respond to the prompt. For example, when the generative response engine is a language model, it might recognize that it is being asked to output an image, and therefore, it needs to interface with a model that can output images to provide a response to the prompt. In another example, the prompt might request a search of the Internet before responding. The generative response engine can use a decision boundary to recognize that it should conduct a search of the Internet and use the results of that search in responding to the prompt. In another example, the prompt might request that the generative response engine take an agentic action on behalf of the user by interacting with a third-party service (e.g., book a reservation for me at...), and the generative response engine can utilize a decision boundary to recognize that it needs to plan steps to locate the third-party service, contact the third-party service, and interact with the third-party service to complete the task and then report back to the user that the action has been completed.

When generative response engine 110 determines that it should take an agentic action on behalf of the user or it should call a tool to aid in providing a quality response to the user account, the generative response engine 110 might call a tool 130 or cause an action 122 to be performed. As indicated above, tools 130 can include internet browsers, editors such as code editors, other AI tools etc. Actions 122 are actions that the generative response engine 110 can cause to be performed, perhaps using tool 130. As used herein actions 122 should be considered to cover a broad array of actions that generative response engine 110 can perform with or without tools 130. Tools 130 are considered to cover a wide variety of services and software that encompass tools such as a computer operating system such that the generative response engine 110 can control the computer operating system on the user's behalf, to robotic actuators, to search browsers and specific applications.

Additionally, the generative response engine 110 can also generate portions of responses that are not displayed to the user. For example, the generative response engine 110 can direct the front end 102 to provide specific behaviors, such as directions for how to present the response from the generative response engine 110 to the user account. In another example, the generative response engine 110 can provide response portions dictated by an API, where portions of the response to the API might be for the consumption of the calling application but not for presentation to the end user. In another example, some generative response engine 110 are reasoning models, which are generative response engine 110 that are configured to output a raw chain-of-thought before preparing a final response to a prompt. The raw chain-of-thought might not be presented to a user account or application calling an API. Instead, another generative response engine 110 might summarize the raw chain-of-thought into a more consumable and useful output for the user account or application.

In some aspects, the output of generative response engine can be further analyzed by output safety system 136. While generative response engine 110 can perform some of its own moderation, there can be instances where it is desired to have another service review outputs for compliance with the moderation policy. The use of dashed lines in FIG. 1 differentiates a path using output safety system 136 and not using output safety system 136.

While FIG. 1 shows responses being provided back to front end 102 directly, in some aspects, the responses might be returned by way of context management service 120.

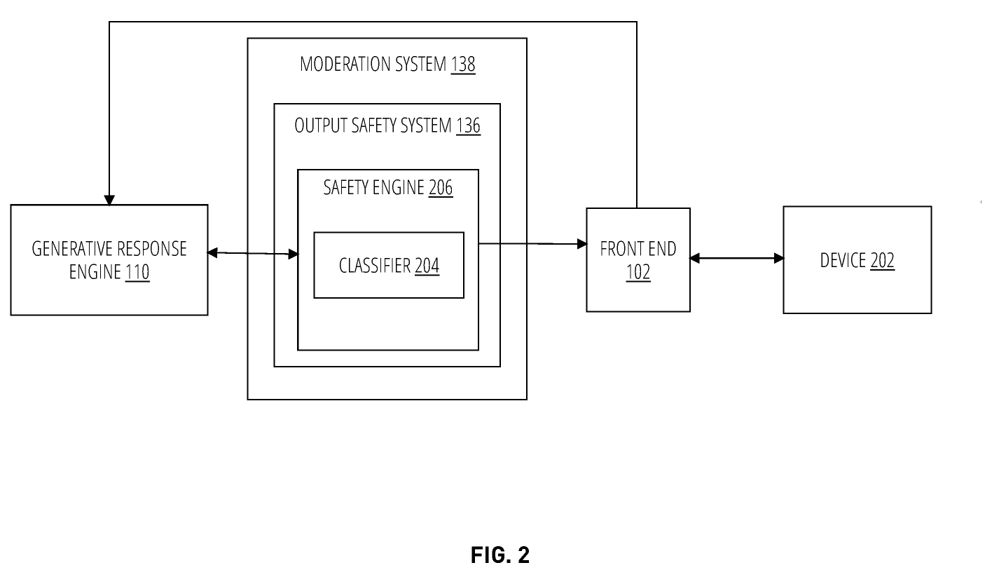

FIG. 2 illustrates another example AI assistant service supporting a generative response engine during inference operations in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

In FIG. 2, generative response engine 110 may output audio content in response to a prompt received via front end 102 from a user account. Generative response engine 110 may output audio content as a stream of tokens. Before providing the audio content to front end 102 for being output to device 202, generative response engine 110 can stream tokens to safety engine 206 of output safety system 136 as the tokens are output by generative response engine 110.

Safety engine 206 can be configured to analyze the output tokens to determine whether the output audio content should be provided to device 202 as output. For example, safety engine 206 can be used to determine whether the output audio content contains a voice that deviates from a voice derived from an allowed voice samples and/or whether the output audio content contains music.

Safety engine 206 can include a classifier 204. Classifier 204 can be an ML model trained to complete a task or tasks. Classifier 204 can be configured to receive audio output and classify whether audio output contains a voice that deviates from a voice generated using an allowed voice sample. In one example, classifier 204 may include an ML model that is trained to identify and quantify deviations of a voice in an audio sample (e.g., the audio output) from a reference voice (e.g., a voice generated by generative response engine 110 from a voice sample). The ML model trained for this task can be a small ML model having fewer parameters and layers than the generative response engine and is configured for a single classification task. Classifier 204 can be configured to output a deviation score, where the deviation score indicates an amount of deviation of a voice in the audio output from a reference voice. In some examples, generative response engine 110 may be trained to output audio content containing a voice generated to match a reference voice or may be trained to not output music. In such cases, classifier 204 can be used for logging output of generative response engine 110, e.g., to log characteristics of the audio output. In another example, safety engine 206 can use classifier 204 to confirm that generative response engine 110 is outputting allowed audio content.

Classifier 204 can output a deviation score for respective windows of the audio output. The windows of audio output can be of predetermined length and can be at least partially overlapping. For example, a first audio window can partially overlap with a second audio window, and the second audio window can overlap with a third audio window. Classifier 204 can output a deviation score for each successive audio window as the audio output is received from generative response engine 110. Safety engine 206 can compare the score with a deviation score threshold to determine whether the audio output can be provided to front end 102 for output to device 202. For example, safety engine 206 can determine not to output the audio output if the respective deviation scores in two sequential audio windows are greater than the deviation score threshold.

If the deviation scores determined based on two sequential windows of audio output are greater than the deviation score threshold, safety engine 206 can provide a message to generative response engine 110 to cause generative response engine 110 to cease output of further audio. Simultaneously or in tandem, safety engine 206 can provide, to front end 102, a message to be provided to the user account via device 202 indicating that generative response engine 110 is unable to provide a response to the prompt.

If the deviation score in a particular audio window is less than the deviation score threshold (e.g., the voice in the audio output of the particular audio window does not deviate from the reference voice beyond an allowed amount), safety engine 206 can provide the audio output to front end 102, which, in turn, streams the audio output to device 202. Similarly, if the deviation score in the particular audio window is greater than the deviation score threshold, but the deviation score for an audio window immediately following or preceding the particular audio window is less than the deviation score threshold, the audio output in the particular audio window can be provided to front end 102 for output to device 202.

In another example, classifier 204 can be configured to receive audio output and classify whether the audio output contains music. In one example, classifier 204 may include an ML model that is trained to identify whether an audio sample contains music. For example, the ML model can be trained to identify when an audio sample contains one or more parameters indicative of music, such as a rhyme scheme (e.g., indicative of lyrics), variations in pitch and tone, and/or percussive beats. The ML model trained for this task can be a small ML model having fewer parameters and layers based on a single classification task. Classifier 204 can be configured to output a music score, where the music score indicates a likelihood that the audio output contains music. In some examples, the music score classifier and the deviation score classifier can be the same model (e.g., classifier 204). In other examples, the music score classifier and the deviation score classifier are different models.

Classifier 204 can output a music score for respective windows of the audio output. Classifier 204 can output the music score for each successive audio window as the audio output is received from generative response engine 110. Safety engine 206 can compare the music score with a music score threshold to determine whether the audio output can be provided to front end 102 for output to device 202. For example, safety engine 206 can determine not to output the audio output if the respective music scores in two sequential audio windows are greater than the music score threshold (e.g., indicating that audio output of both audio windows contains music).

If the music scores determined based on two sequential windows of audio output are greater than the music score threshold, safety engine 206 can provide a message to generative response engine 110 to cause generative response engine 110 to cease output of further audio. Simultaneously or in tandem, safety engine 206 can provide, to front end 102, a message to be provided to the user account via device 202 indicating that generative response engine 110 is unable to provide a response to the prompt.

If the music score in a particular audio window is less than the music score threshold (e.g., no music was detected in the audio output of the particular audio window), safety engine 206 can provide the audio output to front end 102, which, in turn, streams the audio output to device 202. Similarly, if the music score in the particular audio window is greater than the music score threshold, but the music score for an audio window immediately following or preceding the particular audio window is less than the music score threshold, the audio output in the particular audio window can be provided to front end 102 for output to device 202.

In some examples, the determination of whether to output the audio to front end 102 can be based on a single audio frame for both voice deviation and music detection or for either voice deviation or music detection. Further, the sensitivity of safety engine 206 can be tuned by varying the deviation score threshold and/or music score threshold. For example, by increasing the deviation score threshold, the deviation score required to prevent audio output will need to be higher to stop the output, meaning the system will allow a greater amount of deviation from the reference voice. In another example, decreasing the music score threshold may cause prevention of a greater amount of audio output because more audio samples will be classified as containing music.

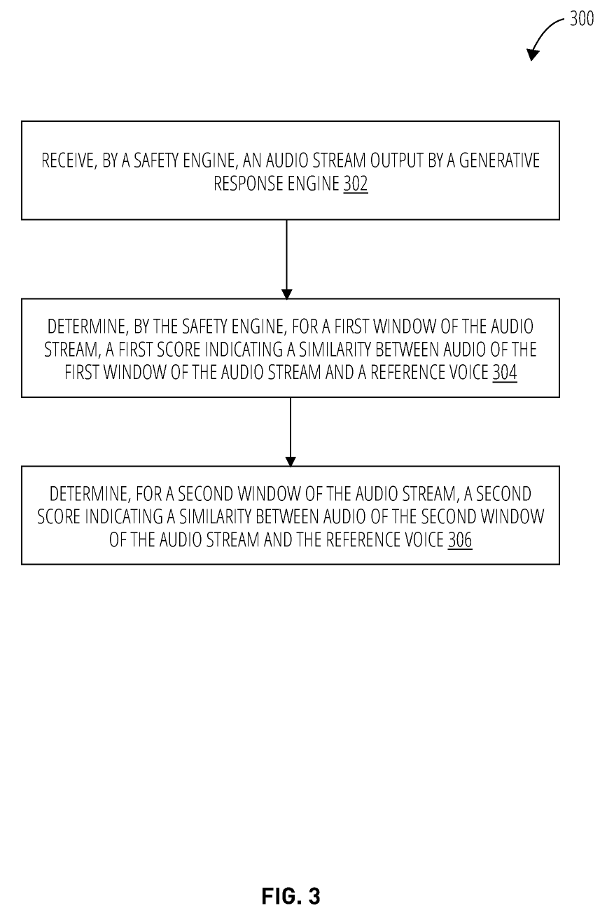

FIG. 3 illustrates an example method 300 for determining whether to provide audio output of a generative response engine based on whether the audio output contains a voice deviating from a reference voice. Although example method 300 depicts a particular sequence of operations, the sequence may be altered without departing from the scope of the present disclosure. For example, some of the operations depicted may be performed in parallel or in a different sequence that does not materially affect the function of method 300. In other examples, different components of an example device or system that implements method 300 may perform functions at substantially the same time or in a specific sequence.

In block 302, method 300 may include receiving, by a safety engine, an audio stream output by a generative response engine. For example, safety engine 206 can receive an audio stream output by generative response engine 110. In some examples, the audio stream may be output by generative response engine 110 in response to receiving, from front end 102, a prompt. The prompt may be received at front end 102 from a user account (e.g., via device 202). The prompt can include an explicit request for audio output, or the user account may be interacting with generative response engine 110 where generative response engine 110 is functioning in an audio conversation or voice mode. In some examples, the generative response engine is a multi-modal transformer model. The generative response engine may, for example, have at least 1 billion parameters. In some examples, the generative response engine is a transformer-based language model adapted to accept text, audio, and vision inputs. In other examples, the generative response engine is a distilled version of a larger model having at least 1 billion parameters.

In block 304, method 300 may include determining, by the safety engine, for a first window of the audio stream, a first score indicating a similarity between the audio of the first window of the audio stream and a reference voice, where the first score is output from a classifier. For example, safety engine 206 may receive an audio stream from generative response engine 110 and divide the audio stream into sequential, overlapping windows as the audio stream is received. For a first window of the audio stream, the classifier can output a score, where the score indicates an amount of deviation from a reference voice. For example, the greater the score, the more a voice in the output audio deviates from the reference voice. The score could account for, for example, deviations in tone, pitch, intonation, etc. In some examples, safety engine 206 can have access to a database of reference voices available to generative response engine 110.

The reference voice used by generative response engine 110 to generate output may be one or more recorded voice samples from a database accessible to generative response engine 110 and/or safety engine 206. The one or more recorded voice samples may be samples recorded by voice actors that are licensed for use in generating, by generative response engine 110, audio output. In some examples, in generating audio output, generative response engine 110 may select a voice sample from which to generate the audio output based on the prompt provided by the user account.

In block 306, method 300 may include determining, for a second window of the audio stream, a second score indicating a similarity between the audio of the second window of the audio stream and the reference voice, where the second score is output from the classifier. As with the first window of the audio output, the score for the second window of audio output can indicate a deviation of a voice in the audio output from the reference voice.

The first score and the second score can be used (e.g., by safety engine 206 and/or front end 102) to determine whether to output the audio of the first window and the second window. For example, safety engine 206 may transmit a message to front end 102. The message can include the first score and the second score. Front end 102 can compare the respective scores with a deviation score threshold to determine whether the respective scores are greater than the deviation score threshold. If both scores are greater than the deviation score threshold, front end 102 can provide a message to generative response engine 110 configured to cause generative response engine 110 to stop outputting tokens. Simultaneously or in sequence, front end 102 can provide a message to the user account indicating that generative response engine 110 is unable to provide output for the prompt. If the scores for both the first window of the audio output and the second window of the audio output are both less than the deviation score threshold (e.g., a voice in the audio output does not deviate from the reference voice or deviates by an allowed amount), the audio output is provided to the user account.

In some examples, the score for the first window of audio output may be less than the deviation score threshold and the score for the second window of audio output may be greater than the deviation score threshold. In this example, front end 102 may continue to output the audio output while the score is not greater than the deviation score threshold for two consecutive windows of the audio output. Further in this example, if a score of a third window of audio output is greater than the deviation score threshold, front end 102 may provide the message to generative response engine 110 to cease output of tokens and may provide a message to the user account that further output cannot be provided. Accordingly, output is ceased once the scores of the audio output in two consecutive windows are greater than (or greater than or equal to) the deviation score threshold.

In some examples, safety engine 206, rather than front end 102, may compare the scores with the deviation score threshold and may communicate messages to generative response engine 110 to stop output of further tokens, and to front end 102 to indicate to the user account that further output cannot be provided. Additionally, in some examples, the deviation score threshold can be adjusted by an administrative user to either increase or decrease sensitivity. Further, in some examples, a score less than the deviation score threshold may indicate that a voice in the audio deviates from a reference voice beyond an allowable amount. In this example, output from generative response engine 110 may be ceased when the scores of the audio output in two consecutive windows are less than, or less than or equal to, the deviation score threshold.

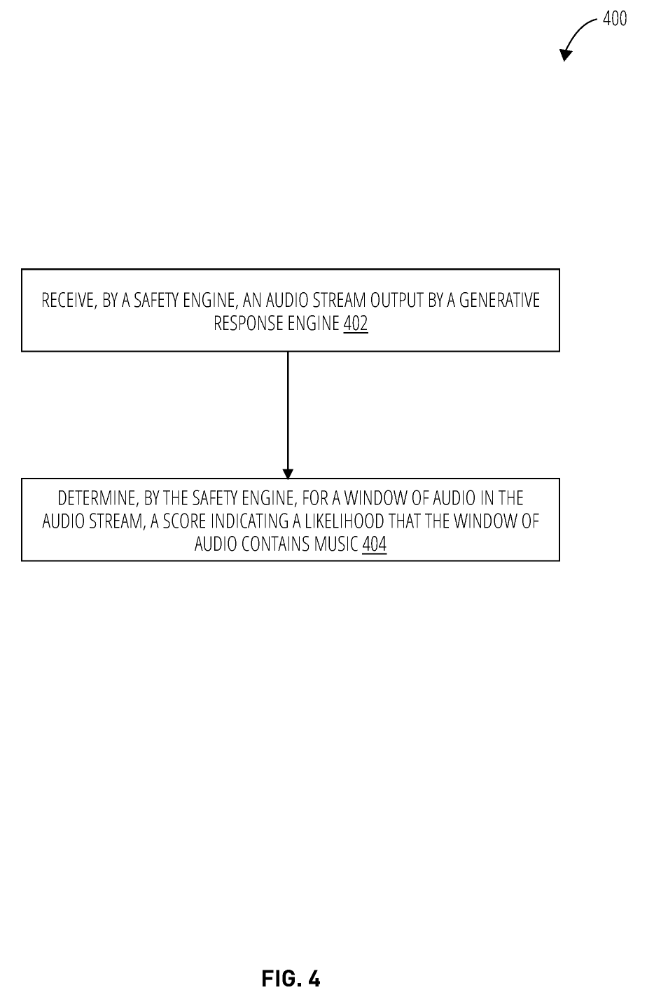

FIG. 4 illustrates an example method 400 for determining whether to provide audio output of a generative response engine based on whether the audio output contains music. Although example method 400 depicts a particular sequence of operations, the sequence may be altered without departing from the scope of the present disclosure. For example, some of the operations depicted may be performed in parallel or in a different sequence that does not materially affect the function of method 400. In other examples, different components of an example device or system that implements method 400 may perform functions at substantially the same time or in a specific sequence.

In block 402, method 400 may include receiving, by a safety engine, an audio stream output by a generative response engine. For example, safety engine 206 can receive an audio stream output by generative response engine 110. In some examples, front end 102 may receive a prompt from a user account and provide the prompt to generative response engine 110. In response to the prompt, generative response engine 110 can output an audio stream to safety engine 206. In some examples the prompt can explicitly request that the generative response engine output music, or the prompt can include an implicit request for music or for output containing one or more musical characteristics. In some examples, the generative response engine is a multi-modal transformer model. The generative response engine may, for example, have at least 1 billion parameters. In some examples, the generative response engine is a transformer-based language model adapted to accept text, audio, and vision inputs. In other examples, the generative response engine is a distilled version of a larger model having at least 1 billion parameters.

In block 404, method 400 may include determining, by the safety engine, for a window of audio in the audio stream, a score indicating a likelihood that the window of audio contains music, where the score is output by a classifier. For example, safety engine 206 can receive a score, output by classifier 204, indicative of whether audio output in the window of audio contains music. For example, the greater the score, the greater the likelihood that the audio output of the audio window contains music. The score can be reflective of the audio output containing one or more musical characteristics, such as a beat, rhythm, tune, etc. The score can be usable (e.g., by safety engine 206 and/or front end 102) to determine whether to output the audio in the window of audio.

In some examples, classifier 204 can be trained to output the score based on training data including music from a public music library and/or synthetic music. Synthetic music can include audio samples generated by a generative response engine (e.g., generative response engine 110) where respective audio samples contain one or more musical characteristics.

In some examples, safety engine 206 may transmit a message to front end 102, where the message includes the score. For example, safety engine 206 can receive the score output by classifier 204 and transmit the score to front end 102. Front end 102 can compare the score with a music score threshold. If the score for the audio output is greater than the music score threshold (or greater than or equal to the music score threshold), front end 102 can provide a message to generative response engine 110 configured to cause generative response engine 110 to stop outputting tokens. Simultaneously or in sequence, front end 102 can provide a message to the user account indicating that generative response engine 110 is unable to provide output for the prompt. If the score is less than the music score threshold, front end 102 can continue to output the audio as safety engine 206 determines the scores for subsequent audio windows.

In some examples, as with the deviation score, safety engine 206 may determine respective scores for a sequence of overlapping windows of the audio output. In this example, safety engine 206 may communicate the respective scores to front end 102 such that front end 102 can communicate to generative response engine 110 to cease token output if the respective scores of two consecutive windows of audio output are greater than the music score threshold.

In some examples, safety engine 206, rather than front end 102, may compare the scores with the music score threshold and may communicate messages to generative response engine 110 to stop output of further tokens, and to front end 102 to indicate to the user account that further output cannot be provided. Additionally, in some examples, the music score threshold can be adjusted by an administrative user to either increase or decrease sensitivity. Further, in some examples, a score less than the music score threshold may indicate that music is present in the audio output. In this example, output from generative response engine 110 may be ceased when the score of the audio output in the windows of audio output is less than, or less than or equal to, the music score threshold.

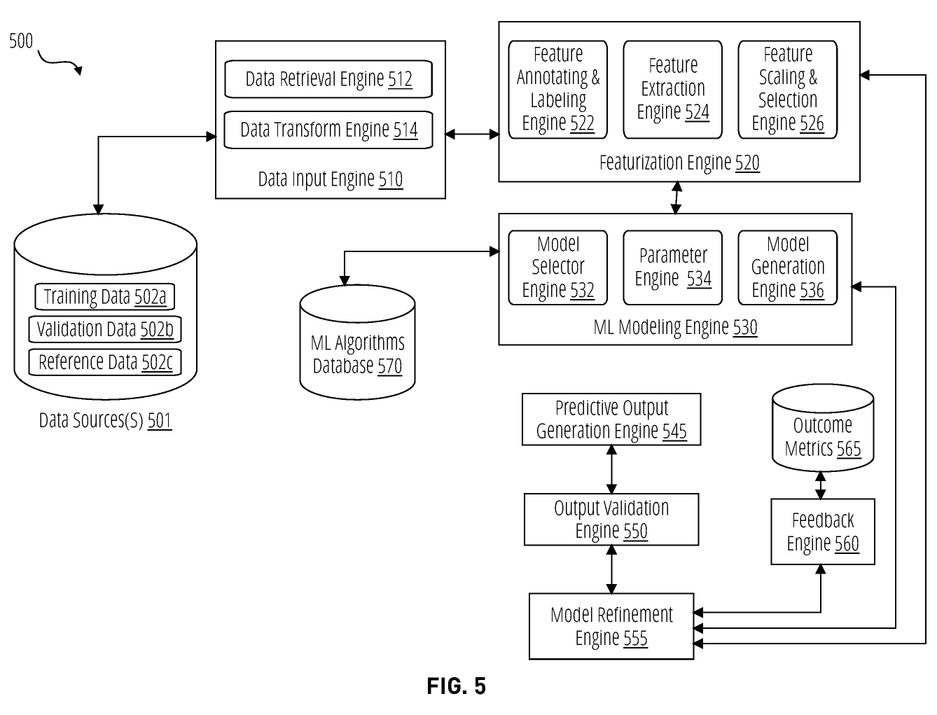

FIG. 5 is a block diagram illustrating an example machine learning platform for implementing various aspects of this disclosure in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

System 500 may include data input engine 510 that can further include data retrieval engine 512 and data transform engine 514. Data retrieval engine 512 may be configured to access, interpret, request, or receive data, which may be adjusted, reformatted, or changed (e.g., to be interpretable by another engine, such as data input engine 510). For example, data retrieval engine 512 may request data from a remote source using an API. Data input engine 510 may be configured to access, interpret, request, format, re-format, or receive input data from data sources(s) 501. For example, data input engine 510 may be configured to use data transform engine 514 to execute a re-configuration or other change to data, such as a data dimension reduction. In some aspects, data sources(s) 501 may be associated with a single entity (e.g., organization) or with multiple entities. Data sources(s) 501 may include one or more of training data 502a (e.g., input data to feed a machine learning model as part of one or more training processes), validation data 502b (e.g., data against which at least one processor may compare model output with, such as to determine model output quality), and/or reference data 502c. In some aspects, data input engine 510 can be implemented using at least one computing device. For example, data from data sources(s) 501 can be obtained through one or more I/O devices and/or network interfaces. Further, the data may be stored (e.g., during execution of one or more operations) in a suitable storage or system memory. Data input engine 510 may also be configured to interact with a data storage, which may be implemented on a computing device that stores data in storage or system memory.

System 500 may include featurization engine 520. Featurization engine 520 may include feature annotating & labeling engine 522 (e.g., configured to annotate or label features from a model or data, which may be extracted by feature extraction engine 524), feature extraction engine 524 (e.g., configured to extract one or more features from a model or data), and/or feature scaling & selection engine 526 Feature scaling & selection engine 526 may be configured to determine, select, limit, constrain, concatenate, or define features (e.g., AI features) for use with AI models.

System 500 may also include machine learning (ML) ML modeling engine 530, which may be configured to execute one or more operations on a machine learning model (e.g., model training, model re-configuration, model validation, model testing), such as those described in the processes described herein. For example, ML modeling engine 530 may execute an operation to train a machine learning model, such as adding, removing, or modifying a model parameter. Training of a machine learning model may be supervised, semi-supervised, or unsupervised. In some aspects, training of a machine learning model may include multiple epochs, or passes of data (e.g., training data 502a) through a machine learning model process (e.g., a training process). In some aspects, different epochs may have different degrees of supervision (e.g., supervised, semi-supervised, or unsupervised). Data into a model to train the model may include input data (e.g., as described above) and/or data previously output from a model (e.g., forming a recursive learning feedback). A model parameter may include one or more of a seed value, a model node, a model layer, an algorithm, a function, a model connection (e.g., between other model parameters or between models), a model constraint, or any other digital component influencing the output of a model. A model connection may include or represent a relationship between model parameters and/or models, which may be dependent or interdependent, hierarchical, and/or static or dynamic. The combination and configuration of the model parameters and relationships between model parameters discussed herein are cognitively infeasible for the human mind to maintain or use. Without limiting the disclosed aspects in any way, a machine learning model may include millions, billions, or even trillions of model parameters. ML modeling engine 530 may include model selector engine 532 (e.g., configured to select a model from among a plurality of models, such as based on input data), parameter engine 534 (e.g., configured to add, remove, and/or change one or more parameters of a model), and/or model generation engine 536 (e.g., configured to generate one or more machine learning models, such as according to model input data, model output data, comparison data, and/or validation data).

In some aspects, model selector engine 532 may be configured to receive input and/or transmit output to ML algorithms database 570. Similarly, featurization engine 520 can utilize storage or system memory for storing data and can utilize one or more I/O devices or network interfaces for transmitting or receiving data. ML algorithms database 570 may store one or more machine learning models, any of which may be fully trained, partially trained, or untrained. A machine learning model may be or include, without limitation, one or more of (e.g., such as in the case of a metamodel) a statistical model, an algorithm, a neural network (NN), a convolutional neural network (CNN), a generative neural network (GNN), a Word2Vec model, a bag of words model, a term frequency-inverse document frequency (tf-idf) model, a GPT (Generative Pre-trained Transformer) model (or other autoregressive model), a diffusion model, a diffusion-transformer model, an encoder such as BERT (Bidirectional Encoder Representations from Transformers) or LXMERT (Learning Cross-Modality Encoder Representations from Transformers), a Proximal Policy Optimization (PPO) model, a nearest neighbor model (e.g., k nearest neighbor model), a linear regression model, a k-means clustering model, a Q-Learning model, a Temporal Difference (TD) model, a Deep Adversarial Network model, or any other type of model described further herein. Some of the ML algorithms in ML algorithms database 570 can be considered generative response engines. Generative response engines are those models are commonly referred to as Generative AI, and that can receive an input prompt and generate additional content based on the prompt. GPTs, diffusion models, and diffusion-transformer models are some non-limiting examples of generative response engines. Some specific examples of generative response engines that can be stored in the ML algorithms database 570 include versions DALL·E, CHAT GPT, and SORA, all provided by OPEN AI.

System 500 can further include predictive output generation engine 545 and output validation engine 550 (e.g., configured to apply validation data to machine learning model output). Predictive output generation engine 545 can analyze the input and identify relevant patterns and associations in the data it has learned to generate a sequence of words that predictive output generation engine 545 predicts is the most likely continuation of the input using one or more models from the ML algorithms database 570, aiming to provide a coherent and contextually relevant answer. Predictive output generation engine 545 generates responses by sampling from the probability distribution of possible words and sequences, guided by the patterns observed during its training. In some aspects, predictive output generation engine 545 can generate multiple possible responses before presenting the final one. Predictive output generation engine 545 can generate multiple responses based on the input, and these responses are variations that predictive output generation engine 545 considers potentially relevant and coherent. Output validation engine 550 can evaluate these generated responses based on certain criteria. These criteria can include relevance to the prompt, coherence, fluency, and sometimes adherence to specific guidelines or rules, depending on the application. Based on this evaluation, output validation engine 550 selects the most appropriate response. This selection is typically the one that scores highest on the set criteria, balancing factors like relevance, informativeness, and coherence.

System 500 can further include feedback engine 560 (e.g., configured to apply feedback from a user and/or machine to a model) and model refinement engine 555 (e.g., configured to update or re-configure a model). In some aspects, feedback engine 560 may receive input and/or transmit output (e.g., output from a trained, partially trained, or untrained model) to outcome metrics database 565. Outcome metrics database 565 may be configured to store output from one or more models and may also be configured to associate output with one or more models. In some aspects, outcome metrics database 565, or other device (e.g., model refinement engine 555 or feedback engine 560), may be configured to correlate output, detect trends in output data, and/or infer a change to input or model parameters to cause a particular model output or type of model output. In some aspects, model refinement engine 555 may receive output from predictive output generation engine 545 or output validation engine 550. In some aspects, model refinement engine 555 may transmit the received output to featurization engine 520 or ML modeling engine 530 in one or more iterative cycles.

The engines of system 500 may be packaged functional hardware units designed for use with other components or a part of a program that performs a particular function (e.g., of related functions). Any or each of these modules may be implemented using a computing device. In some aspects, the functionality of system 500 may be split across multiple computing devices to allow for distributed processing of the data, which may improve output speed and reduce computational load on individual devices. In some aspects, system 500 may use load-balancing to maintain stable resource load (e.g., processing load, memory load, or bandwidth load) across multiple computing devices and to reduce the risk of a computing device or connection becoming overloaded. In these or other aspects, the different components may communicate over one or more I/O devices and/or network interfaces.

System 500 can be related to different domains or fields of use. Descriptions of aspects related to specific domains, such as natural language processing or language modeling, is not intended to limit the disclosed aspects to those specific domains, and aspects consistent with the present disclosure can apply to any domain that utilizes predictive modeling based on available data.

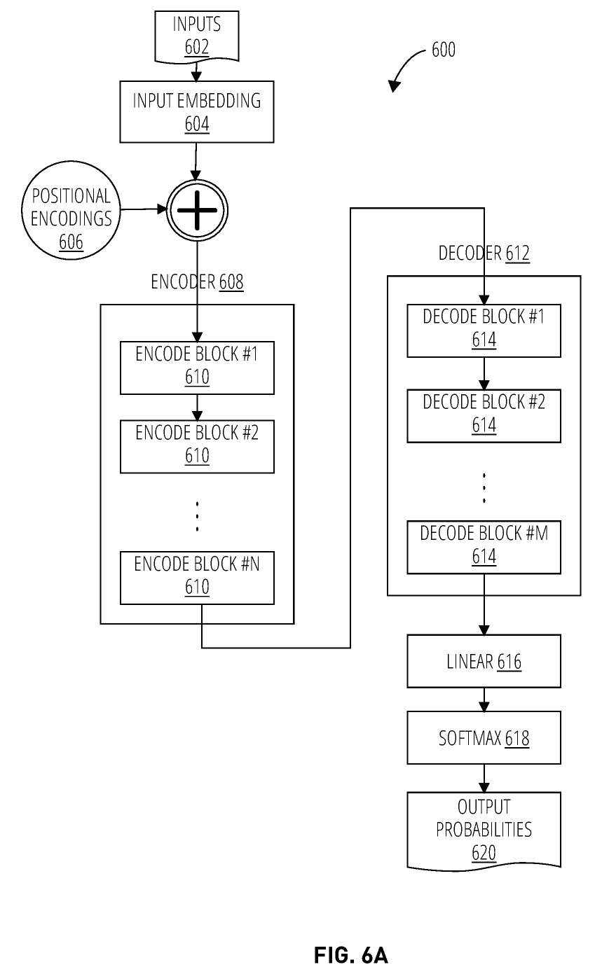

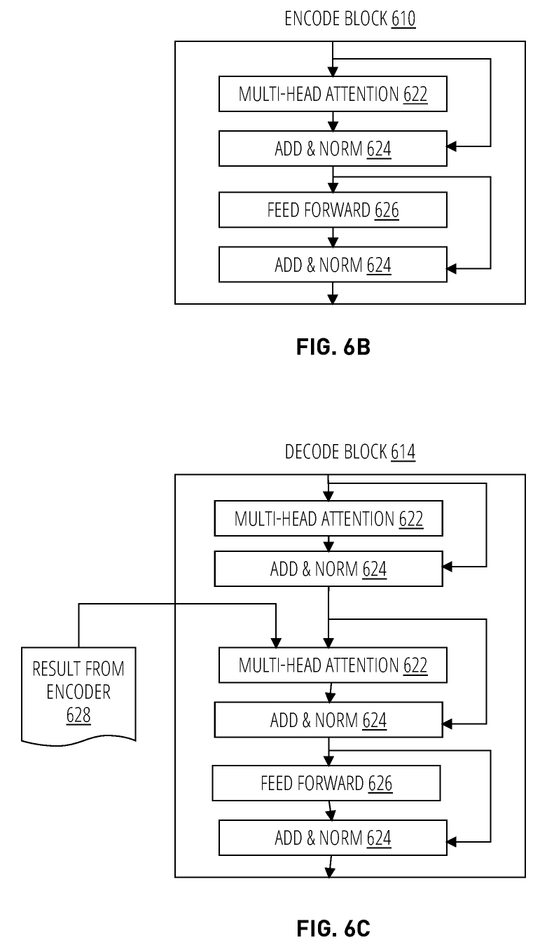

FIGS. 6A, 6B, and 6C illustrates an example transformer architecture in accordance with some aspects of the present technology. Examples of ML models that use a transformer neural network (e.g., transformer architecture 600) can include, e.g., generative pretrained transformer (GPT) models and Bidirectional Encoder Representations from Transformer (BERT) models. The transformer architecture 600, which is illustrated in FIGS. 6A, 6B, and 6C, includes inputs 602, input embedding block 604, positional encodings 606, encoder 608 including encode blocks 610, decoder 612 including decode blocks 614, linear block 616, softmax block 618, and output probabilities 620.

Input embedding block 604 is used to provide representations for words. For example, embedding can be used in text analysis. According to certain non-limiting examples, the representation is a real-valued vector that encodes the meaning of the word in such a way that words that are closer in the vector space are expected to be similar in meaning. Word embeddings can be obtained using language modeling and feature learning techniques, where words or phrases from the vocabulary are mapped to vectors of real numbers. According to certain non-limiting examples, the input embedding block 604 can be learned embeddings to convert the input tokens and output tokens to vectors of dimension that have the same dimension as the positional encodings, for example.

Positional encodings 606 provide information about the relative or absolute position of the tokens in the sequence. According to certain non-limiting examples, positional encodings 606 can be provided by adding positional encodings to the input embeddings at the inputs to the encoder 608 and decoder 612. The positional encodings have the same dimension as the embeddings, thereby enabling a summing of the embeddings with the positional encodings. There are several ways to realize the positional encodings, including learned and fixed. For example, sine and cosine functions having different frequencies can be used. That is, each dimension of the positional encoding corresponds to a sinusoid. Other techniques of conveying positional information can also be used, as would be understood by a person of ordinary skill in the art. For example, learned positional embeddings can instead be used to obtain similar results. An advantage of using sinusoidal positional encodings rather than learned positional encodings is that doing so allows the model to extrapolate to sequence lengths longer than the ones encountered during training.

Encoder 608 can use stacked self-attention and point-wise, fully connected layers. Encoder 608 can be a stack of N identical layers (e.g., N = 6), and each layer can be an encode block, as illustrated by encode block 610 shown in FIG. 6B. Each encode block 610 has two sub-layers: (i) a first sub-layer has a multi-head attention block 622 and (ii) a second sub-layer has a feed forward block 626, which can be a position-wise fully connected feed-forward network. The feed forward block 626 can use a rectified linear unit (ReLU).

Encoder 608 uses a residual connection around each of the two sub-layers, followed by an add & norm block 624, which performs normalization. For example, the output of each sub-layer can be LayerNorm(x+ Sublayer(x)). To facilitate these residual connections, all sub-layers in the model, as well as the embedding layers, produce output data having a same dimension.

Similar to encoder 608, decoder 612 uses stacked self-attention and point-wise, fully connected layers. Decoder 612 can also be a stack of M identical layers (e.g., M = 6), and each layer can be a decode block, as illustrated by decode block 612 shown in FIG. 6B. In addition to the two sub-layers (i.e., the sublayer with multi-head attention block 622 and the sub-layer with feed forward block 626) found in encode block 610, decode block 614 can include a third sub-layer, which performs multi-head attention over the output of the encoder stack. Similar to encoder 608, decoder 612 uses residual connections around each of the sub-layers, followed by layer normalization. Additionally, the sub-layer with multi-head attention block 622 can be modified in the decoder stack to prevent positions from attending to subsequent positions. This masking, combined with the fact that the output embeddings are offset by one position, can ensure that the predictions for position i can depend only on the known output data at positions less than i.

Linear block 616 can be a learned linear transformation. For example, when transformer architecture 600 is being used to translate from a first language into a second language, linear block 616 can project the output from the last decode softmax block 618 into word scores for the second language (e.g., a score value for each unique word in the target vocabulary) at each position in the sentence. For instance, if the output sentence has seven words and the provided vocabulary for the second language has 10,000 unique words, then 10,000 score values are generated for each of those seven words. The score values indicate the likelihood of occurrence for each word in the vocabulary in that position of the sentence.

Softmax block 618 then turns the scores from linear block 616 into output probabilities 620 (which add up to 1.0). In each position, the index provides for the word with the highest probability, and then maps that index to the corresponding word in the vocabulary. Those words then form the output sequence of transformer architecture 600. The softmax operation is applied to the output from linear block 616 to convert the raw numbers into output probabilities 620 (e.g., token probabilities).

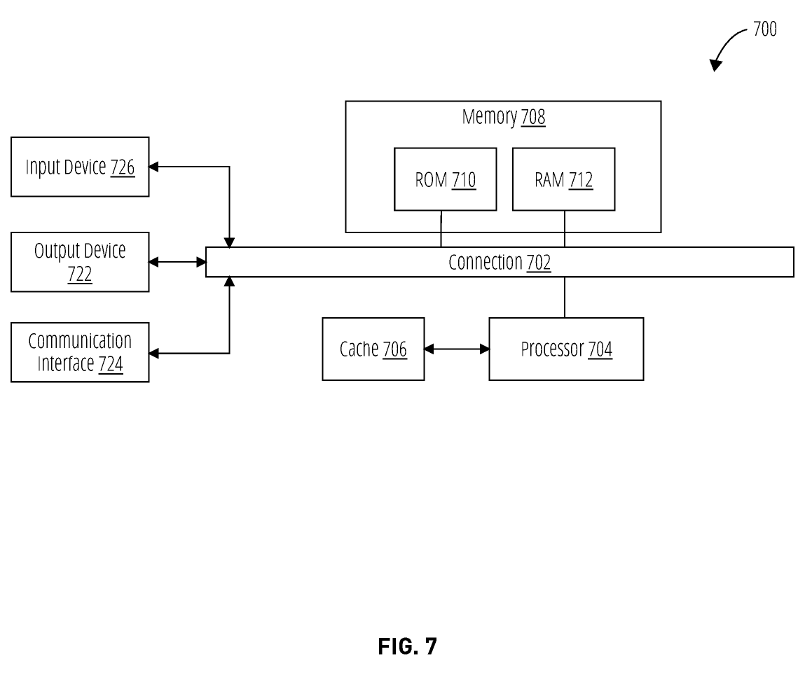

FIG. 7 shows an example of computing system 700, which can be, for example, any computing device making up any engine illustrated in FIG. 1 or any component thereof.

In some aspects, computing system 700 is a single device, or a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

In some aspects, computing system 700 may comprise one or more computing resources provisioned from a “cloud computing” provider, For example, AMAZON ELASTIC COMPUTE CLOUD (“AMAZON EC2”), provided by AMAZON, INC. of Seattle, Washington; SUN CLOUD COMPUTER UTILITY, provided by SUN MICROSYSTEMS, INC. of Santa Clara, California; AZURE, provided by MICROSOFT CORPORATION of Redmond, Washington, GOOGLE CLOUD PLATFORM, provided by ALPHABET, INC. of Mountain View, California, and the like.

Example computing system 700 includes at least one processing unit (CPU or processor) 704 and connection 702 that couples various system components including system memory 708, such as read-only memory (ROM) 710 and random access memory (RAM) 712 to processor 704. Memory 708 can be a volatile or non-volatile memory device, and can be a hard disk or other types of non-transitory computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

Memory 708 can include software services, servers, logic, etc., that when the code that defines such software is executed by the processor 704, it causes the system to perform a function. In some aspects, a hardware service that performs a particular function can include the software component stored in a computer-readable medium in connection with the necessary hardware components, such as processor 704, connection 702, output device 722, etc., to carry out the function.

Computing system 700 can include a cache of high-speed memory 706 connected directly with, in close proximity to, or integrated as part of processor 704.

Connection 702 can be a physical connection via a bus, or a direct connection into processor 704, such as in a chipset architecture. Connection 702 can also be a virtual connection, networked connection, or logical connection.

Processor 704 can include any general purpose processor and a hardware service or software service stored in memory 708, configured to control processor 704 as well as a special-purpose processor where software instructions are incorporated into the actual processor design. Processor 704 may essentially be a completely self-contained computing system, containing multiple cores or processors, a bus, memory controller, cache, etc. A multi-core processor may be symmetric or asymmetric. Processor 704 can be physcial or virtual.

To enable user interaction, computing system 700 includes an input device 726, which can represent any number of input mechanisms, such as a microphone for speech, a touch-sensitive screen for gesture or graphical input, keyboard, mouse, motion input, speech, etc. Computing system 700 can also include output device 722, which can be one or more of a number of output mechanisms known to those of skill in the art. In some instances, multimodal systems can enable a user to provide multiple types of input/output to communicate with computing system 700. Computing system 700 can include communication interface 724, which can generally govern and manage the user input and system output. There is no restriction on operating on any particular hardware arrangement, and therefore the basic features here may easily be substituted for improved hardware or firmware arrangements as they are developed.

In some aspects, computing system 700 can refer to a combination of a personal computing device interacting with components hosted in a data center, where both the computing device and the components in the data center. In such examples, both the personal computing device and the components in the datacenter might have a processor, cache, memory, storage, etc.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some aspects, a service can be software that resides in memory of a client device and/or one or more servers of a content management system and perform one or more functions when a processor executes the software associated with the service. In some aspects, a service is a program or a collection of programs that carry out a specific function. In some aspects, a service can be considered a server. The memory can be a non-transitory computer-readable medium.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware, and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Aspects:

Aspect 1: A method comprising: receiving, by a safety engine, an audio stream output by a generative response engine, wherein the generative response engine is a multi-modal transformer model, wherein the generative response engine has at least 1 billion parameters, wherein the generative response engine is a transformer-based language model adapted to accept text, audio, and vision inputs, wherein the generative response engine is a distilled version of a larger model having at least 1 billion parameters; determining, by the safety engine, for a first window of the audio stream, a first score indicating a similarity between audio of the first window of the audio stream and a reference voice, wherein the first score is output from a classifier; and determining, for a second window of the audio stream, a second score indicating a similarity between audio of the second window of the audio stream and the reference voice, wherein the second score is output from the classifier, wherein the first score and the second score are usable in determining whether to output the first window of the audio stream and the second window of the audio stream.

Aspect 2: The method of Aspect 1, wherein at least a portion of the first window of the audio stream overlaps with at least a portion of the second window of the audio stream.

Aspect 3: The method of any of Aspects 1 or 2, further comprising: comparing the first score with a score threshold to determine that the first window of the audio stream contains voice qualities that deviate from the reference voice beyond an acceptable margin; comparing the second score with the score threshold to determine that the second window of the audio stream contains voice qualities that deviate from the reference voice beyond the acceptable margin; providing, by the safety engine to the generative response engine, a command to cease further output by the generative response engine when the first score and the second score indicate that the voice qualities in the audio in the first window and the audio in the second window that deviate beyond an acceptable margin from the reference voice; and generating, by the safety engine, a response, wherein the response comprises a refusal to respond to a prompt from a user account using the audio stream.

Aspect 4: The method of any of Aspects 1-3, further comprising: comparing the first score with a score threshold to determine that the first window of the audio stream does not contain prohibited content; comparing the second score with the score threshold to determine that the second window of the audio stream contains prohibited content; and transmitting, by the safety engine, the first window of the audio stream and the second window of the audio stream.

Aspect 5: The method of any of Aspects 1-4, further comprising: determining, for a third window of the audio stream, a third score using the classifier of the safety engine, wherein at least a portion of the second window overlaps with at least a third portion of the third window; comparing the third score with the score threshold to determine that the third window contains prohibited content; and based on consecutive windows of the audio stream containing prohibited content: providing, by the safety engine to the generative response engine, a command to cease further output by the generative response engine, and generating, by the safety engine, a response, wherein the response comprises a system message.

Aspect 6: The method of any of Aspects 1-5, wherein the classifier is a model trained on a corpus of audio samples to determine a score indicative of a similarity of an audio sample to a reference sample.

Aspect 7: The method of any of Aspects 1-6, wherein the reference voice is a machine-generated voice generated by a model trained on samples from a human voice actor.

Aspect 8: The method of any of Aspects 1-7, further comprising: training the classifier to output a score using a labelled training data set comprising audio data labelled based on a resemblance of the audio data to a reference voice of a set of reference voices.

Aspect 9: The method of any of Aspects 1-8, wherein the audio data comprises synthetic audio data, wherein the synthetic audio data is generated by a second generative response engine, and wherein the generative response engine is a post-trained version of the second generative response engine.

Aspect 10: The method of any of Aspects 1-9, further comprising: determining, by the safety engine, for the first window of the audio stream and the second window of the audio stream, a music score indicating a presence of at least one musical characteristic in the audio of the first window of the audio stream or the second window of the audio stream, wherein the music score is output from the classifier, and wherein the music score is usable in determining whether to output the first window of the audio stream and the second window of the audio stream.

Aspect 11: The method of any of Aspects 1-10, further comprising: comparing the first score with a score threshold to determine that the first window of the audio stream contains voice qualities that deviate from the reference voice beyond an acceptable margin; comparing the second score with the score threshold to determine that the second window of the audio stream contains voice qualities that deviate from the reference voice beyond the acceptable margin; comparing the music score with a threshold music score to determine that the first window of the audio stream or the second window of the audio stream contains music; providing, by the safety engine to the generative response engine, a command to cease further output by the generative response engine based on either: the first score and the second score indicating that the voice qualities in the audio in the first window and the audio in the second window that deviate beyond an acceptable margin from the reference voice, or the music score indicating that the audio in the first window or the audio in the second window contain music; and generating, by the safety engine, the response, wherein the response comprises a refusal to respond to a prompt from a user account using the audio stream.

Aspect 12: The method of any of Aspects 1-11, wherein the reference voice is one of a set of voice samples stored by the safety system and wherein the method further comprises: receiving, from the generative response engine, an indication of which voice sample of the set of voice samples to use as the reference voice.

Aspect 13. A non-transitory computer-readable medium having stored thereon instructions that, when executed by at least one processor, cause the at least one processor to perform operations according to any of Aspects 1 to 12.

Aspect 14. A computing system for performing a function, comprising one or more means for performing operations according to any of Aspects 1 to 12.

Aspect 15: A method comprising: receiving, by a safety engine, an audio stream output by a generative response engine, wherein the generative response engine is a multi-modal transformer model, wherein the generative response engine has at least 1 billion parameters, wherein the generative response engine is a transformer-based language model adapted to accept text, audio, and vision inputs, wherein the generative response engine is a distilled version of a larger model having at least 1 billion parameters; sending, by the front end, the prompt to the generative response engine; outputting, by the generative response engine, an audio stream to a safety engine; and determining, by the safety engine, for a window of audio in the audio stream, a score indicating a likelihood that the window of audio contains music, wherein the score is output by a classifier, wherein the score is usable in determining whether to output the window of audio.

Aspect 16: The method of aspect 15, further comprising: comparing, by the front end, the score with a score threshold to determine that the window of audio contains musical characteristics; providing, by the safety engine to the generative response engine, a command to cease further output by the generative response engine; and generating, by the safety engine, a response, wherein the response comprises a refusal to respond to a prompt from a user account using the audio stream.

Aspect 17: The method of any of Aspects 15-16, further comprising: determining, by the safety engine, for a second window of audio in the audio stream, a second score indicating a likelihood that the second window of audio contains music, wherein the second score is output by the classifier; comparing, by the front end, the score with a score threshold to determine that the window of audio contains musical characteristics; comparing, by the front end, the second score with a score threshold to determine that the second window of audio contains musical characteristics; providing, by the safety engine to the generative response engine, a command to cease further output by the generative response engine when the score and the second score indicate that the window of audio and the second window of audio, respectively, both contain musical characteristics; and generating, by the safety engine, a response, wherein the response comprises a refusal to respond to a prompt from a user account using the audio stream.

Aspect 18: The method of any of Aspects 15-17, further comprising: training the classifier to output the score using a labelled training data set comprising audio data labelled based on whether the audio data is considered music.

Aspect 19: The method of any of Aspects 15-18, wherein the audio data comprises synthetic audio data, wherein the synthetic audio data is generated by a second generative response engine, and wherein the generative response engine is a post-trained version of the second generative response engine.

Aspect 20. A non-transitory computer-readable medium having stored thereon instructions that, when executed by at least one processor, cause the at least one processor to perform operations according to any of Aspects 15 to 19.

Aspect 21. A computing system for performing a function, comprising one or more means for performing operations according to any of Aspects 15 to 19.

The present technology includes computer-readable storage mediums for storing instructions, and systems for executing any one of the methods embodied in the instructions addressed in the aspects of the present technology presented below:

What is claimed is:

1. A method comprising:
receiving, by a safety engine, an audio stream output by a generative response engine;
determining, by the safety engine, for a first window of the audio stream, a first score indicating a similarity between audio of the first window of the audio stream and a reference voice, wherein the first score is output from a classifier; and
determining, for a second window of the audio stream, a second score indicating a similarity between audio of the second window of the audio stream and the reference voice, wherein the second score is output from the classifier, wherein the first score and the second score are usable in determining whether to output the first window of the audio stream and the second window of the audio stream.

2. The method of claim 1, wherein at least a portion of the first window of the audio stream overlaps with at least a portion of the second window of the audio stream.

3. The method of claim 1, further comprising:
comparing the first score with a score threshold to determine that the first window of the audio stream contains voice qualities that deviate from the reference voice beyond an acceptable margin;
comparing the second score with the score threshold to determine that the second window of the audio stream contains voice qualities that deviate from the reference voice beyond the acceptable margin;
providing, by the safety engine to the generative response engine, a command to cease further output by the generative response engine when the first score and the second score indicate that the voice qualities in the audio in the first window and the audio in the second window that deviate beyond an acceptable margin from the reference voice; and
generating, by the safety engine, a response, wherein the response comprises a refusal to respond to a prompt from a user account using the audio stream.

4. The method of claim 1, further comprising:
comparing the first score with a score threshold to determine that the first window of the audio stream does not contain prohibited content;
comparing the second score with the score threshold to determine that the second window of the audio stream contains prohibited content; and
transmitting, by the safety engine to a front end to the generative response engine, the first window of the audio stream and the second window of the audio stream.

5. The method of claim 4, further comprising:
determining, for a third window of the audio stream, a third score using the classifier of the safety engine, wherein at least a portion of the second window overlaps with at least a third portion of the third window;
comparing the third score with the score threshold to determine that the third window contains prohibited content; and
based on consecutive windows of the audio stream containing prohibited content:
providing, by the safety engine to the generative response engine, a command to cease further output by the generative response engine, and
generating, by the safety engine, a response, wherein the response comprises a system message.

6. The method of claim 1, wherein the classifier is a model trained on a corpus of audio samples to determine a score indicative of a similarity of an audio sample to a reference sample.

7. The method of claim 1, wherein the reference voice is a machine-generated voice generated by a model trained on samples from a human voice actor.

8. A computing system comprising:
at least one processor; and
a memory storing instructions that, when executed by the at least one processor, configure the computing system to:
receive an audio stream output by a generative response engine;
determine, for a first window of the audio stream, a first score indicating a similarity between audio of the first window of the audio stream and a reference voice, wherein the first score is output from a classifier; and
determine, for a second window of the audio stream, a second score indicating a similarity between audio of the second window of the audio stream and the reference voice, wherein the second score is output from the classifier, wherein the first score and the second score are usable in determining whether to output the first window of the audio stream and the second window of the audio stream.

9. The computing system of claim 8, wherein at least a portion of the first window of the audio stream overlaps with at least a portion of the second window of the audio stream.

10. The computing system of claim 8, wherein the instructions further configure the computing system to:
train the classifier to output a score using a labelled training data set comprising audio data labelled based on a resemblance of the audio data to a reference voice of a set of reference voices.

11. The computing system of claim 10, wherein the audio data comprises synthetic audio data, wherein the synthetic audio data is generated by a second generative response engine, and wherein the generative response engine is a post-trained version of the second generative response engine.

12. The computing system of claim 8, wherein the instructions further configure the computing system to:
determine for the first window of the audio stream and the second window of the audio stream, a music score indicating a presence of at least one musical characteristic in the audio of the first window of the audio stream or the second window of the audio stream, wherein the music score is output from the classifier and wherein the music score is usable in determining whether to output the first window of the audio stream and the second window of the audio stream.

13. The computing system of claim 12, wherein the instructions further configure the computing system to:
compare the first score with a score threshold to determine that the first window of the audio stream contains voice qualities that deviate from the reference voice beyond an acceptable margin;
compare the second score with the score threshold to determine that the second window of the audio stream contains voice qualities that deviate from the reference voice beyond the acceptable margin;
compare the music score with a threshold music score to determine that the first window of the audio stream or the second window of the audio stream contains music;
provide, to the generative response engine, a command to cease further output by the generative response engine based on any one of:
the first score and the second score indicating that the voice qualities in the audio in the first window and the audio in the second window that deviate beyond an acceptable margin from the reference voice, and
the music score indicating that the audio in the first window or the audio in the second window contain music; and
generate a response, wherein a response comprises a refusal to respond to a prompt from a user account using the audio stream.

14. The computing system of claim 8, wherein the reference voice is one of a set of voice samples stored by a safety system and wherein the instructions further configure the computing system to:
receive, from the generative response engine, an indication of which voice sample of the set of voice samples to use as the reference voice.

15. A non-transitory computer-readable medium comprising instructions that when executed by at least one processor, cause the at least one processor to:
receive an audio stream output by a generative response engine;
determine, for a first window of the audio stream, a first score indicating a similarity between audio of the first window of the audio stream and a reference voice, wherein the first score is output from a classifier; and
determine, for a second window of the audio stream, a second score indicating a similarity between audio of the second window of the audio stream and the reference voice, wherein the second score is output from the classifier, wherein the first score and the second score are usable in determining whether to output the first window of the audio stream and the second window of the audio stream.

16. The non-transitory computer-readable medium of claim 15, wherein at least a portion of the first window of the audio stream overlaps with at least a portion of the second window of the audio stream.

17. The non-transitory computer-readable medium of claim 15, wherein the instructions further configure the at least one processor to:
compare the first score with a score threshold to determine that the first window of the audio stream contains voice qualities that deviate from the reference voice beyond an acceptable margin;
compare the second score with the score threshold to determine that the second window of the audio stream contains voice qualities that deviate from the reference voice beyond the acceptable margin;
provide, to the generative response engine, a command to cease further output by the generative response engine when the first score and the second score indicate that the voice qualities in the audio in the first window and the audio in the second window that deviate beyond an acceptable margin from the reference voice; and
generate a response, wherein the response comprises a refusal to respond to a prompt from a user account using the audio stream.

18. The non-transitory computer-readable medium of claim 15, wherein the instructions further configure the at least one processor to:
compare the first score with a score threshold to determine that the first window of the audio stream does not contain prohibited content;
compare the second score with the score threshold to determine that the second window of the audio stream contains prohibited content; and
transmit to a front end to the generative response engine, the first window of the audio stream and the second window of the audio stream.

19. The non-transitory computer-readable medium of claim 18, wherein the instructions further configure the at least one processor to:
determine, for a third window of the audio stream, a third score using the classifier, wherein at least a portion of the second window overlaps with at least a third portion of the third window;
compare the third score with the score threshold to determine that the third window contains prohibited content; and
based on consecutive windows of the audio stream containing prohibited content:
provide, to the generative response engine, a command to cease further output by the generative response engine, and
generate a response, wherein the response comprises a system message.

20. The non-transitory computer-readable medium of claim 15, wherein the classifier is a model trained on a corpus of audio samples to determine a score indicative of a similarity of an audio sample to a reference sample.
